(19) United States
(12) Patent Application Publication
(10) Pub. No.: US 2014/0232737 A1
(43) Pub. Date: Aug. 21, 2014

(54) DISPLAY ADJUSTMENT METHOD, SYSTEM AND ELECTRONIC DEVICE

(71) Applicants: BEIJING LENOVO SOFTWARE LTD., Beijing (CN); LENOVO (BEIJING) CO., LTD., Beijing (CN)

(72) Inventors: Min Zhang, Beijing (CN); Zhenhua Zhang, Beijing (CN); Ke Shang, Beijing (CN)

(73) Assignees: BEIJING LENOVO SOFTWARE LTD., Beijing (CN); LENOVO (BEIJING) CO., LTD., Beijing (CN)

(21) Appl. No.: 14/348,457

(22) PCT Filed: Feb. 21, 2013
(86) PCT No.: PCT/CN2013/071722

§ 371 Date: Mar. 28, 2014

(30) Foreign Application Priority Data
Feb. 24, 2012 (CN) 201210046677.X
Sep. 10, 2012 (CN) 201210333244.2

(51) Int. Cl. G09G 5/02

(52) U.S. Cl. CPC G09G 5/02
USPC 345/589

(57) ABSTRACT

A display adjustment method, system and electronic device. The method comprises: determining whether a touch sensing unit generates a color cast to obtain a first determination result; when the touch sensing unit generates a color cast, determining whether the color cast meets a preset condition to obtain a second determination result; and when the second determination result indicates that the color cast meets the preset condition, adjusting display parameters of a display unit based on the color cast, so as to correct the color cast. The technical solution provided in the embodiment of the disclosure can effectively correct the problem of the color cast of the display screen caused by a reason such as the used material or display structure and enhance the display effect.

### CROSS REFERENCE OF RELATED APPLICATION

The application claims priority to Chinese patent application No. 201210046677.X, titled “DISPLAY ADJUSTING METHOD, SYSTEM AND ELECTRONIC DEVICE” and filed with the State Intellectual Property Office on Feb. 24, 2012, and priority to Chinese patent application No. 201210333244.2, titled “INTERFERENCE REFLECTIVE DISPLAY SCREEN ADJUSTING METHOD AND SYSTEM” and filed with the State Intellectual Property Office on Sep. 10, 2012, which are hereby incorporated by reference in its entirety.

### FIELD

The disclosure relates to the technical field of display screen, and in particular to a display adjusting method, system and an electronic device.

### BACKGROUND

The existing display screen causes chromatic aberration on the displayed image due to reasons such as the used material or display structure, and thus reducing the display quality.

For example, a touch-screen displayer based on a thin-film sensor may cause to display yellowish due to the aging of the material, and therefore it may cause chromatic aberration.

As for an interference reflective display screen, since it is an interference modulation based reflective technique, the interference reflective display screen uses the ambient light as light sources and does not need backlight. The interference reflective display screen may be adjusted in accordance with the surrounding light conditions automatically, and a user may view it under almost all the environments. The interference reflective display screen adopts a set of microscopic display structures, which is referred as a pixel unit. Currently, since the positions of pixels are set unreasonably in a display screen, the display effect of a display screen is affected.

### SUMMARY

In order to solve the above technical problems, it is provided a display adjusting method, system and electronic device in an embodiment of the disclosure, for improving the display effect of a display screen. The technical solutions are as follows.

In an embodiment of the disclosure, it is provided a display adjusting method applied to an electronic device including a display unit which has a touch function and includes a touch sensing unit adapted to receive a touch operation of a user, where the method includes:

judging whether chromatic aberration is generated in the touch sensing unit to obtain a first judgment result;

judging whether the chromatic aberration meets a preset condition to obtain a second judgment result in the case where the first judgment result indicates that the chromatic aberration is generated in the touch sensing unit; and

adjusting display parameters of the display unit based on the chromatic aberration to correct the chromatic aberration in the case where the second judgment result indicates that the chromatic aberration meets the preset condition.

In an embodiment of the disclosure, it is provided another display adjusting method, and the method includes:

acquiring first relative position information between a first pixel unit of an interference reflective display screen and a first area in a range illuminated by the first pixel unit; and

adjusting an angle of the first pixel unit in accordance with the first relative position information.

In an embodiment of the disclosure, it is provided a display adjusting system including a first acquiring unit and a first adjusting unit, where:

the first acquiring unit is adapted to acquire first relative position information between a first pixel unit of an interference reflective display screen and a first area in a range illuminated by the first pixel unit; and

the first adjusting unit is adapted to adjust the angle of the first pixel unit in accordance with the first relative position information.

In an embodiment of the disclosure, it is provided an electronic device including a display unit which has touch ability and includes a touch sensing unit adapted to receive a touch operation of a user, wherein the electronic device further includes a display adjusting apparatus which includes:

a first judging module, adapted to judge whether chromatic aberration is generated in the touch sensing unit to obtain a first judgment result;

a second judging module, adapted to judge whether the chromatic aberration meets a preset condition to obtain a second judgment result in the case where the first judgment result indicates that the chromatic aberration is generated in the touch sensing unit; and

an adjusting module, adapted to adjust display parameters of the display unit based on the chromatic aberration to correct the chromatic aberration in the case where the second judgment result indicates that the chromatic aberration meets the preset condition.

According to the technical solutions provided in the embodiments of the disclosure, the problem of a chromatic aberration of the display screen caused by reasons such as the used material or display structure can be corrected, thus improving the display effect.

### BRIEF DESCRIPTION OF THE DRAWINGS

FIG. 1 is a schematic structural diagram of a display adjusting apparatus according to an embodiment of the disclosure;

FIG. 2 is a schematic flow chart of a display adjusting method according to an embodiment of the disclosure;

FIG. 3 is a schematic flow chart of another display adjusting method according to an embodiment of the disclosure;

FIG. 4 is a schematic flow chart of another display adjusting method according to an embodiment of the disclosure;

FIG. 5 is a schematic flow chart of another display adjusting method according to an embodiment of the disclosure;

FIG. 6 is a schematic flow chart of another display adjusting method according to an embodiment of the disclosure;

FIG. 7 is a schematic flow chart of another display adjusting method according to an embodiment of the disclosure;

FIG. 8 is a schematic flow chart of another display adjusting method according to an embodiment of the disclosure;

FIG. 9 is a schematic flow chart of another display adjusting method according to an embodiment of the disclosure;

FIG. 10 is a schematic diagram of adjusting a pixel unit of an interference reflective display screen according to an embodiment of the disclosure;

FIG. 11 is a schematic diagram of adjusting a pixel unit of an interference reflective display screen according to an embodiment of the disclosure;

FIG. 12 is a schematic flow chart of another display adjusting method according to an embodiment of the disclosure;

FIG. 13 is a schematic structural diagram of a display adjusting system according to an embodiment of the disclosure;

FIG. 14 is a schematic structural diagram of another display adjusting system according to an embodiment of the disclosure;

FIG. 15 is a schematic structural diagram of another display adjusting system according to an embodiment of the disclosure;

FIG. 16 is a schematic structural diagram of another display adjusting system according to an embodiment of the disclosure;

FIG. 17 is a schematic structural diagram of another display adjusting system according to an embodiment of the disclosure;

FIG. 18 is a schematic structural diagram of another display adjusting system according to an embodiment of the disclosure; and

FIG. 19 is a schematic structural diagram of another display adjusting system according to an embodiment of the disclosure.

### DETAILED DESCRIPTION OF THE EMBODIMENTS

The technical solutions in the embodiments of the disclosure will be described clearly and completely hereinafter in conjunction with the drawings in the embodiments of the disclosure. Apparently, the described embodiments are only a part but not all of the embodiments of the disclosure. All the other embodiments can be obtained by those skilled in the art without creative effort on the basis of the embodiments of the disclosure, which fall within the scope of protection of the disclosure.

A display adjusting method according to an embodiment of the disclosure includes: judging whether chromatic aberration is generated in a touch sensing unit to obtain a first judgment result; judging whether the chromatic aberration meets a preset condition to obtain a second judgment result in the case where the first judgment result indicates that chromatic aberration is generated in the touch sensing unit; and adjusting display parameters of the display unit based on the chromatic aberration to correct the chromatic aberration in the case where the second judgment result indicates that the chromatic aberration meets the preset condition. In the case where chromatic aberration is generated in the touch sensing unit, the display parameters of the display unit are used to correct the chromatic aberration such that the display unit outputs a correct color, thus solving the problem that yellow screen caused by the aging of thin-film materials.

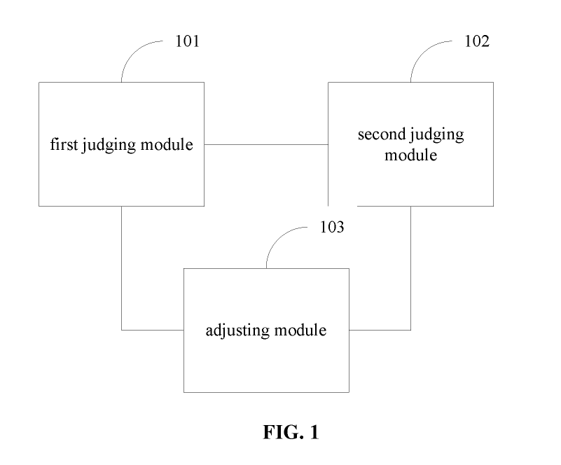

Referring to FIG. 1, an electronic device is provided in an embodiment of the disclosure. The electronic device includes a display unit having a touch function and including a touch sensing unit adapted to receive a touch operation by a user. In an embodiment of the disclosure, the touch sensing unit is a thin-film sensing touch screen. The electronic device further includes at least one display adjusting apparatus, and the display adjusting apparatus includes a first judging module 101, a second judging module 102 and an adjusting module 103.

The first judging module 101 is adapted to judge whether the touch sensing unit generates chromatic aberration to obtain a first judgment result. During the output of the touch sensing unit, the first judging module 101 may judge whether there is chromatic aberration in the output color of the touch sensing unit. Specifically, since each color has its standard color value, the first judging module 101 may compare the actual color value of each color output from the touch sensing unit with its standard color value respectively. It is indicated that chromatic aberration is generated if the comparison result is not consistent. Generally, yellowish chromatic aberration may be generated in display white color, i.e., white color which should be output is seemed yellowish. Accordingly, take that white generates a yellow color cast as an example in an embodiment of the disclosure. The first judging module 101 compares the actual color value of white to be output with its standard color value to obtain the first judgment result. If the comparison result is not consistent (generally, if there is chromatic aberration, it may be that the actual color value is greater than the standard color value), it is judged that chromatic aberration is generated on white color; and if the comparison result is consistent, it is judged that there is no chromatic aberration.

The second judging module 102 is adapted to judge whether the chromatic aberration meets a preset condition to obtain a second judgment result in the case where the first judgment result indicates that the chromatic aberration is generated on the touch sensing unit. In the case where the first judging module 101 determines that chromatic aberration is generated on the touch sensing unit, it is judged that whether the chromatic meets the preset condition. The preset condition may be that the chromatic aberration value of the chromatic aberration is greater than a preset chromatic aberration threshold. In an embodiment of the disclosure, take that yellowish chromatic aberration is generated in display white color as an example. For example, the preset chromatic aberration threshold is A, and the chromatic aberration value of white is B, if B>A, it is determined that the chromatic aberration meets the preset chromatic aberration threshold. There may be only one preset chromatic aberration threshold, i.e., it is judged by one preset chromatic aberration threshold that whether each color meets the preset condition. Alternatively, a preset chromatic aberration threshold may be set for each color respectively, and it is judged by the preset chromatic aberration threshold corresponding to a different color respectively that whether the different color meets the preset condition.

The adjusting module 103 is adapted to adjust display parameters of the display unit based on the chromatic aberration to correct the chromatic aberration in the case where the second judgment result indicates that the chromatic aberration meets the preset condition. If the second judging module 102 determines that the chromatic aberration meets the preset condition, the adjusting module 103 adjusts the display parameters of the display unit, i.e., the adjusting module 103 adjusts the output color of the display unit by adjusting the display parameters of the display unit. A manner to adjust the display parameters of the display unit is to adjust the color value of a color output from the display unit. The display parameters at least include a color parameter, brightness, contrast and saturation. For example, if it is determined that yellowish chromatic aberration is generated in display white color, and a chromatic aberration value thereof is determined, the color value of white color output from the display unit may be adjusted to form a complementary color with white output from the touch sensing unit so as to correct the chromatic aberration, or the color value may be adjusted into a preset color value such that a color to be output is a color as anticipated by a user.

For example, an adjusting manner may be to formulate a time-based changing curve of a chromatic aberration value previously in accordance with the analysis of historical data. Specifically, a time-based changing curve of chromatic aberration value of each color may be formulated, and for convenience, only a time-based changing curve of a chromatic aberration value of white may be formulated. The formulated changing curve may be saved in the system, and the adjusting module 103 may determine the current chromatic aberration value in accordance with the formulated changing curve at each moment and thus adjust the display parameters of the display unit, i.e., the adjusting module 103 may adjust the display parameters of the display unit automatically in accordance with the formulated changing curve at each moment. Alternatively, it may also be that a user notifies the electronic device in the case where the user needs to adjust a output color, and the adjusting module 103 adjusts the display parameters of the display unit in accordance with the formulated changing curve on receipt of the notification. For example, the output color of the display unit may be formed as a complementary color with the output color of the touch sensing unit through an adjustment such that the color to be output finally is correct, thus correcting the chromatic aberration. Alternatively, the color output may also be a color as anticipated by a user through an adjustment. Since the changing curve is formulated previously, this adjusting manner may adjust chromatic aberration automatically at each moment, and thus it is simple and convenient.

For example, another adjusting manner may be to place an electronic device in a satisfied white light environment to acquire the current chromatic aberration value in the case where the output color is needed to be adjusted. For example, the current chromatic aberration value may be acquired through a color sensor such that the acquired chromatic aberration value is more exact, where the acquired chromatic aberration value is the chromatic aberration value of the touch sensing unit, and the adjusting module 103 may adjust the display parameters of the display unit in accordance with the acquired chromatic aberration value. For example, the output color of the display unit may be formed as a complementary color with the output color of the touch sensing unit through an adjustment such that the color to be output is correct, thus correcting the chromatic aberration. Alternatively, the final output may also be a color as anticipated by a user through an adjustment. When an adjustment is needed, the adjusting manner performs the adjustment after the current exact chromatic aberration value is acquired, so making the adjustment result more exact.

A display adjusting method will be described hereinafter by way of specific embodiments.

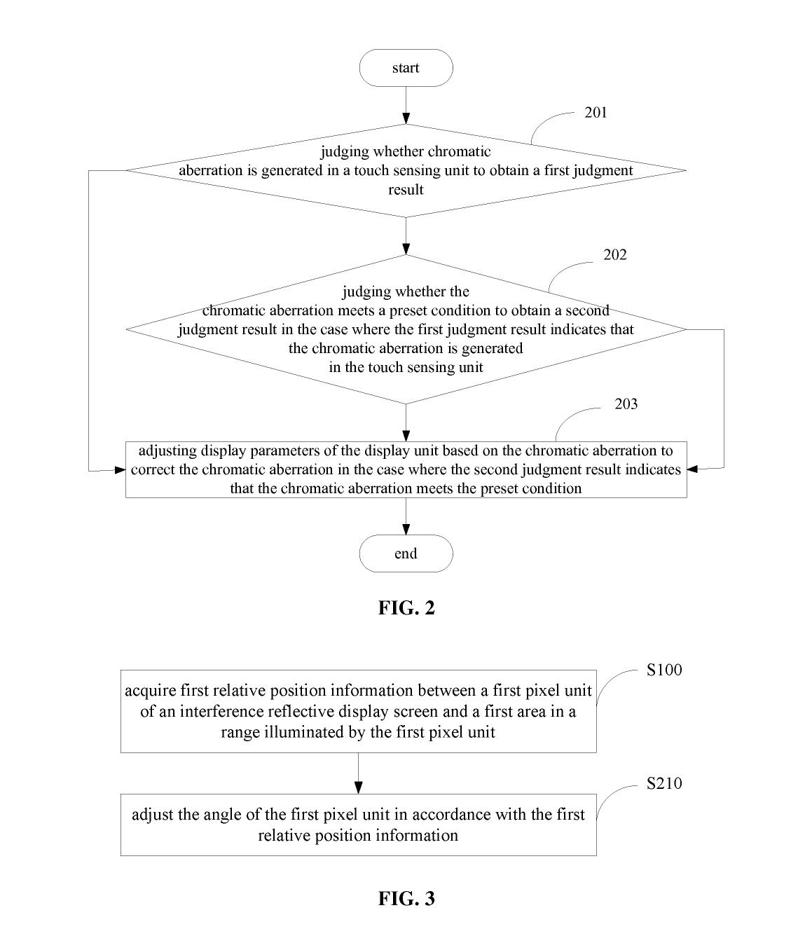

Referring to FIG. 2, the main flow chart of a display adjusting method according to an embodiment of the disclosure is as follows. The method is applied to an electronic device, and the method includes steps 201 to 203.

Step 201 is to judge whether a touch sensing unit generates chromatic aberration to obtain a first judgment result.

Step 202 is to judge whether the chromatic aberration meets a preset condition to obtain a second judgment result in the case where the first judgment result indicates that the touch sensing unit generates chromatic aberration.

Step 203 is to adjust display parameters of a display unit based on the chromatic aberration to correct the chromatic aberration in the case where the second judgment result indicates that the chromatic aberration meets the preset condition.

The display adjusting method according to an embodiment includes: judging whether the touch sensing unit generates chromatic aberration to obtain a first judgment result; judging whether the chromatic aberration meets a preset condition to obtain a second judgment result in the case where the first judgment result indicates that the touch sensing unit generates chromatic aberration; and adjusting display parameters of the display unit based on the chromatic aberration to correct the chromatic aberration in the case where the second judgment result indicates that the chromatic aberration meets the preset condition. In the case where chromatic aberration is generated on the touch sensing unit, the display parameters of the display unit are adjusted to correct the chromatic aberration such that the display unit outputs a correct color, thus solving the problem that the yellowish screen caused by the aging of thin-film materials and meeting user requirements. There are many kinds of adjusting manners to be selected by a user as required.

As shown in FIG. 3, another display adjusting method according to an embodiment of the disclosure includes steps S100 and S200.

S100 is to acquire first relative position information between a first pixel unit of an interference reflective display screen and a first area within a range illuminated by the first pixel unit.

The interference reflective display screen relates to the reflective technology based on interference modulation, which uses the ambient light as a light source and does not need backlight.

It should be understood that, there may be many pixel units in the interference reflective display screen, and each pixel unit may be adjusted by the method according to the disclosure.

It is to be noted that, a pixel unit of an interference reflective display screen generally has an illumination range due to the obstruction of various objects (for example, interior walls). For example, in the case where an interference reflective display screen is placed in a sitting room, the illumination range of a pixel unit of the interference reflective display screen may be the sitting room. In the case where a viewer views image information displayed on the interference reflective display screen, the viewer is generally within the illumination range of the pixel unit of the interference reflective display screen. For example, if an interference reflective display screen is placed in a sitting room, if a viewer wants to view the image information displayed on the interference reflective display screen, he should be in the sitting room, and not be outside the illumination range of a pixel unit of the interference reflective display screen (for example, another room separated by a wall).

The first area may be an area where a viewer is located.

The intensity of light interfered by a thin-film which is generated by a pixel unit of the interference reflective display screen may be obtained in accordance with the following Equation:

I=I1+I2+2A1*A2*cos θ=I1+I2+2A1*A2*cos(2Π*ΔL/λ). formula (1)

In formula (1), I denotes the intensity of interference light, I1 denotes the light intensity of interference beam 1, I2 denotes the intensity of interference beam 2, A1 denotes the amplitude of interference beam 1, A2 denotes the amplitude of interference beam 2, ΔL denotes an optical path difference between two interference beams, λ denotes the wave length of an interference light, and θ denotes the phase difference between interference beam 1 and interference beam 2.

In the case where ΔL=mλ/2 (where m is an integer), the light is enhanced due to the light coherent. It should be understood that, when interference beam 1 and interference beam 2 both emit along the normal direction of an air thin-film, ΔL is twice the thickness of the air thin-film (i.e., twice the distance between two reflecting layers). The thickness of the air thin-film is adjusted in such a way that ΔL meets ΔL=mλ₁/2. According to Equation (1), after interference, the intensity of light whose wave length is λ₁ is maximized. While if light is slanting into an eye under this thickness of the air thin-film, the optical path difference between two interference beams may deviate ΔL, and the wave length of the corresponding interfered light is λ₂, and λ₁ is not equal to λ₂, so chromatic aberration is generated. That is, the existing interference reflective display screen has the problem of generating chromatic aberration.

Since only the light ray the emitting direction of which deviates far away from the normal of a pixel unit can be seen in the case where a viewer is located far away from the normal of the pixel unit, the optical deflection is generated. The angel of the pixel unit may be adjusted based on the relative position relationship between the pixel unit and the position of the viewer, such that the viewer can view the light emitted from a position nearby the normal of the pixel unit without moving, and avoiding the optical deflection. Certainly, in the case where the viewer moves, according to the disclosure, the angle of the pixel unit may be adjusted in accordance with the position of the viewer so as to prevent from generating chromatic aberration.

The first area may also be an area where a light source is located.

Since the interference reflective display screen uses the ambient light as a light source, in the case where that the orientation of the display screen deviates from a light source which has a greater light intensity, the intensity of light emitted from the display screen is lower. While in the case where a light source the light intensity of which is greater is located in the normal direction of the display screen, the intensity of a light lay emitted from the display screen is too high. Accordingly, the existing interference reflective display screen has the problem that its display brightness is not appropriate.

It should be understood that, since the interference reflective display screen is a display screen which uses the ambient light as a display light source, the intensity of the light illuminating the interference reflective display causes a great impact on the brightness of the screen of the interference reflective display screen. In the case where the first area is an area where the light source is located, the pixel unit is adjusted in accordance with the relative position relationship between the pixel unit and the area where the light source is located, such that the interference reflective display screen can be illuminated by the light which has an appropriated light intensity and the optimization of the brightness of the interference reflective display screen is achieved.

The first area may also include an area where a viewer is located and an area where a light source is located.

It is to be noted that, in another embodiment of the disclosure, the area where a viewer is located and the area where a light source is located may be regarded as an integral area. Accordingly, it may achieve the effects of avoiding chromatic aberration and optimizing the brightness.

Thus, the first area may include an area where a viewer is located and/or an area where a light source is located.

S200 is to adjust the angle of the first pixel unit in accordance with the first relative position information.

As shown in FIG. 4, the step S200 may include step S210.

S210 is to adjust the angle of the first pixel unit in accordance with the first relative position information such that the normal of the first pixel unit passes through the first area.

In other embodiments of the disclosure, the angle of the first unit may also be adjusted by using other reference line or reference point as a reference. As an example, the vertical line of the center of an outside surface of a first pixel unit may be used.

The horizontal angle of the first pixel unit may be adjusted, the vertical angle of the first pixel unit may be adjusted, or both the horizontal angle and the vertical angle of the first pixel unit may be adjusted.

In practical application, the height of the first pixel unit may be adjusted. For example, if a viewer is tall, the height of the first pixel unit may be adjusted upper so that its height is suitable for the viewer. In addition, the horizontal position of the first pixel unit may be adjusted. For example, the horizontal position of the first pixel unit is adjusted front-back and left-right. It should be understood that, the adjusting manner also has a better practicability. In the case where the position where a viewer is located deviates from the normal direction of the interference reflective display screen, the horizontal direction of the interference reflective display screen may be adjusted such that the viewer is located in the normal direction of the display screen.

In practical application, each pixel unit may be adjusted separately, multiple pixel units may be adjusted uniformly, or the entire interference reflective display screen including all the pixel units may be adjusted, which is not limited here in the disclosure.

In a display adjusting method according to an embodiment of the disclosure, the relative position relationship between a pixel unit of the interference reflective display screen and a first area within a range illuminated by the first pixel unit may be acquired; and the angle of the pixel unit is adjusted in accordance with the relative position information. Since the angle of the interference reflective display screen may be adjusted in accordance with the surrounding environment in the disclosure, it enables the interference reflective display screen to adjust its angle in accordance with the surrounding environment automatically in the disclosure, thus the display effect of the interference reflective display screen is improved.

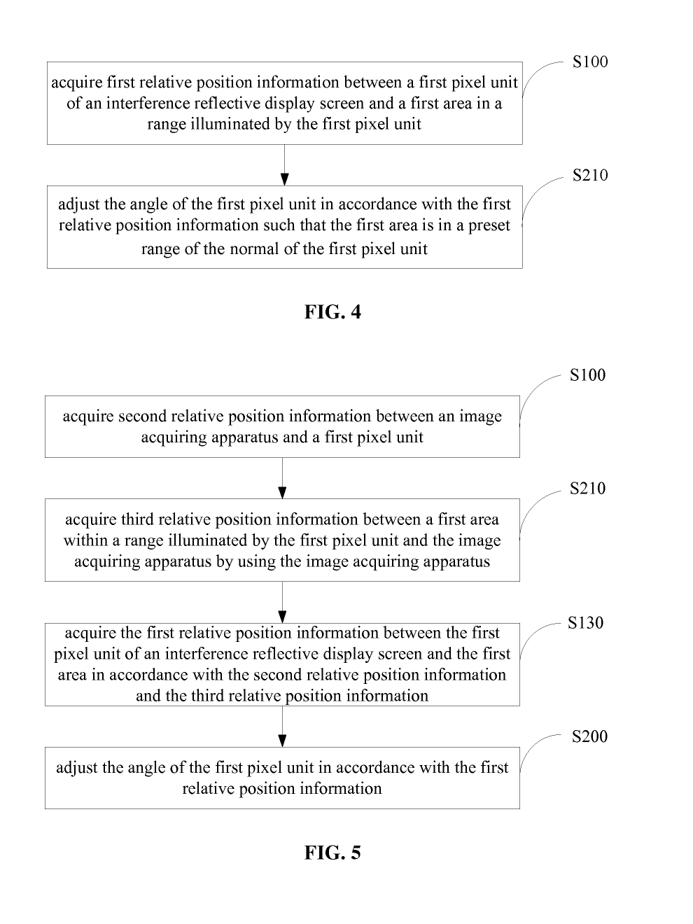

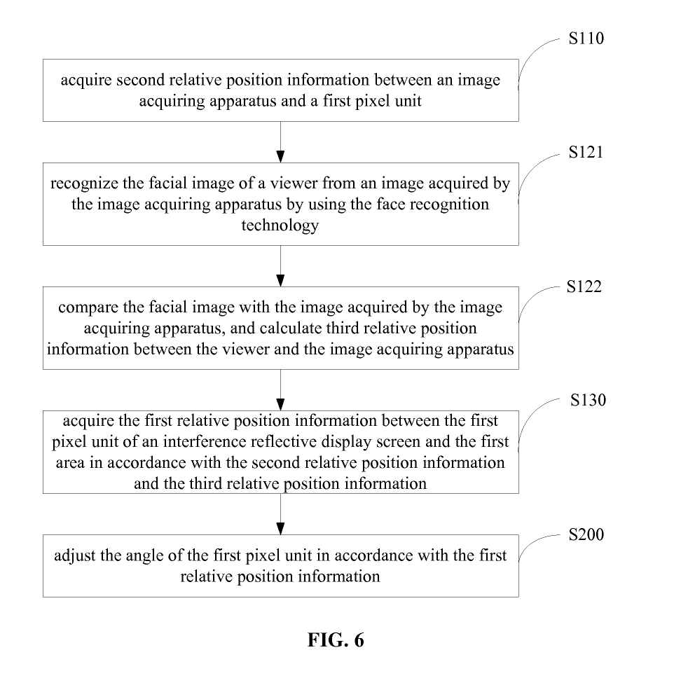

As shown in FIG. 5, in another display adjusting method according to an embodiment of the disclosure, an image acquiring apparatus may be provided on an interference reflective display screen, and step S100 may include steps S110 to S130.

S110 is to acquire second relative position information between the image acquiring apparatus and the first pixel unit.

S120 is to acquire third relative position information between the first area within a range illuminated by the first pixel unit and the image acquiring apparatus by using the image acquiring apparatus.

The image acquiring apparatus may be a camera.

It should be understood that, in order to not affect the display of the display screen and light emitted from the display screen, the image acquiring apparatus is generally provided on the outside of each pixel unit of the display screen, for example, at the upper edge of the display screen. Since only the relative position relationship between the image acquiring apparatus and the first area may be obtained from an image which is acquired from the image acquiring apparatus, it also needs to acquire relative position information between the image acquiring apparatus and the first pixel unit so as to obtain the relative position information between the first pixel unit and the first area.

It is to be noted that, step S110 and step S120 are not limited for the execution sequence, and may be executed simultaneously or successively.

S130 is to acquire the first relative position information between the first pixel unit of the interference reflective display screen and the first area in accordance with the second relative position information and the third relative position information.

It should be understood by those skilled in the art that, the first relative position information between the first pixel unit of the interference reflective display screen and the first area may be acquired by converting relative positions of the second relative position information and the third relative position information.

As shown in FIG. 6, in another display adjusting method according to an embodiment of the disclosure, in the case where the first area is an area where a viewer is located, step S120 may include steps S121 and S122.

S121 is to recognize a facial image of the viewer from an image acquired by the image acquiring apparatus by using the face recognition technology.

The face recognition technology is used to recognize input facial image or video stream based on facial features. It may be judged firstly by the face recognition technology that whether there is a face. If there is a face, the position and size of each face and position information of each main facial organ may be further presented. Furthermore, identity characteristics which are implied in each face may be exacted in accordance with these information, and compared with the faces known, thus the identity of each face is recognized.

In the disclosure, it may only use the technology which judges whether there is a face in the face recognition technology, i.e., it only needs to recognize that there is a face. In another embodiment of the disclosure, it may use all the face recognition technology, and thus may recognize identity features corresponding to a facial image. The specific application may be as follows.

A white list of viewers is stored in advance, and the facial image information of the viewers is associated with the identify information and added into the white list of viewers.

The facial image acquired by the image acquiring apparatus may recognized by using the face recognition technology. If there is a facial image, it is further recognized that whether the facial image corresponds to at least one piece of facial image information of the white list of viewers. If the facial image corresponds to at least one piece of facial image information of the white list of viewers, the corresponding functions after the adjusting method of the interference reflective display screen according to the disclosure is applied in the electronic device are started. If the facial image does not correspond to at least one piece of facial image information of the white list of viewers, the function is not started.

S122 is to compare the facial image with the image acquired by the image acquiring apparatus, and calculate third relative position information between the viewer and the image acquiring apparatus.

It should be understood that, in the case where the on the premise of no zoom, if a face is more far away from the image acquiring apparatus, the facial image is smaller in an image acquired by the image acquiring apparatus. The distance between the face and the image acquiring apparatus may be determined in accordance with the size of the facial image. And the angle relationship between the face and the image acquiring apparatus may be determined in accordance with the distance and position relationship between the facial image and the center of the image acquire by the image acquiring apparatus. Finally, the third relative position relationship may be determined in accordance with the distance and angle obtained above.

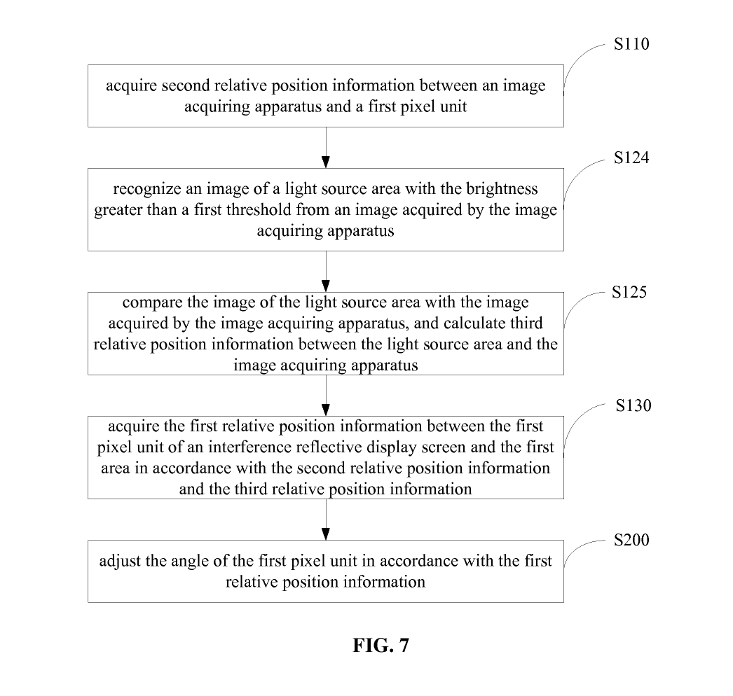

As shown in FIG. 7, in another display adjusting method according to an embodiment of the disclosure, in the case where the first area is an area where a light source is located, step S120 may include steps S124 and S125.

S124 is to recognize an image of a light source area with the brightness greater than a first threshold from an image acquired by the image acquiring apparatus.

It should be understood that, except for self-luminous object, all objects may reflect light ray, therefore all objects may reflect light ray into the interference reflective display screen. Accordingly, objects which may reflect light ray into the interference reflective display screen may all be referred as light sources. The area where the light source is located may be referred as a light source area. It should be understood that, the brightness of an image corresponding to the area where a self-luminous object is located is larger.

In practical application, the brightness value may be obtained by judging the values of the three-color RGB of different positions in an image acquired by the image acquiring apparatus, and then compared with a first threshold to determine a light source area. For example, if the values of three-color RGB are all maximums, the corresponding part of the image is white and the brightness vale thereof is maximal may be determined as a light source with great brightness. Since determining brightness value from an image is known by those skilled in the art, for convenience, it is not described herein.

S125 is to compare the image of the light source area with the image acquired by the image acquiring apparatus, and calculate third relative position information between the light source area and the image acquiring apparatus.

The comparison manner between an image of a light source and an image acquired by an image acquiring apparatus is the same as that between a facial image and an image acquired by an image acquiring apparatus in an embodiment as shown in FIG. 5. Please refer to the corresponding description for the specific manner.

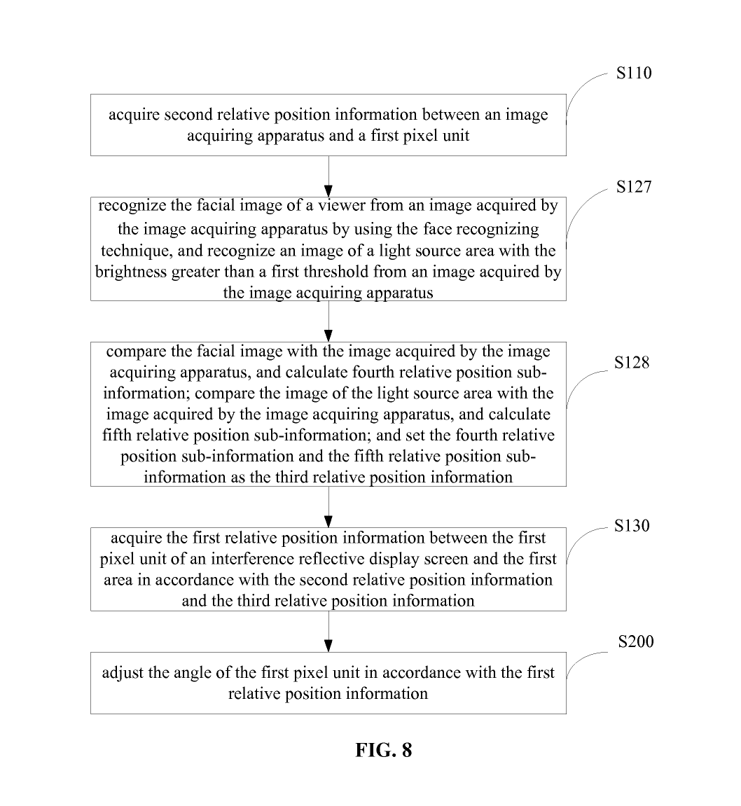

As shown in FIG. 8, in another display adjusting method according to an embodiment of the disclosure, in the case where the first area includes an area where a viewer is located and an area where a light source is located, step S120 may include steps S127 and S128.

Step S127 is to recognize a facial image of the viewer from the image acquired by the image acquiring apparatus by using the face recognition technology, and recognize an image of the light source area with the brightness greater than a first threshold from the images acquired by the image acquiring apparatus.

In practical application, in the case where a facial image and an image of a light source area are acquired by image acquiring apparatus, the facial image and the image of a light source area may be recognized.

S128 is to compare the facial image with the image acquired by the image acquiring apparatus, and calculate fourth relative position sub-information; compare the image of a light source area with the image acquired by the image acquiring apparatus, and calculate fifth relative position sub-information; and set the fourth relative position sub-information and the fifth relative position sub-information as the third relative position information which indicates that the relative position between the first area in the illumination rang of the first pixel unit and the image acquiring apparatus.

After the facial image and the image of a light source are recognized, the fourth relative position relationship between the facial image and the image acquiring apparatus and the fifth relative position relationship between the light source and the image acquiring apparatus may be obtained respectively, and the fourth relative position relationship and the fifth relative position relationship are set together as the third relative position relationship used to adjust the angle of the display screen, so as to solve the problem of chromatic aberration and inappropriate brightness.

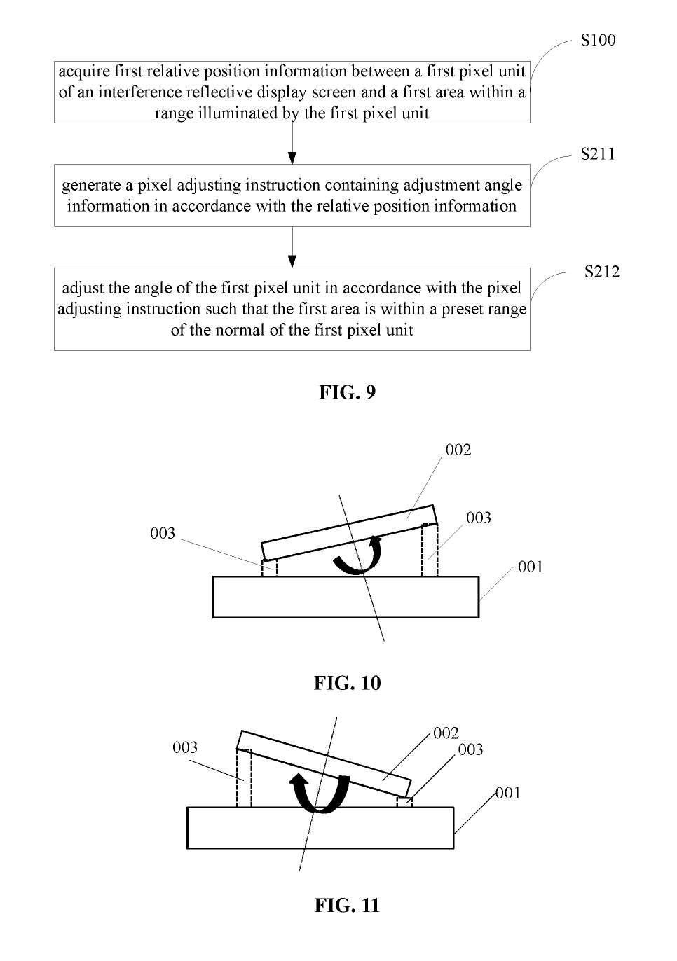

As shown in FIG. 9, in another display adjusting method according to an embodiment of the disclosure, step S210 may include steps S211 and S212.

S211 is to generate a pixel adjusting instruction containing adjustment angle information in accordance with the first relative position information.

In the case where a preset range is ±5° and the first relative position information between the first area and the first pixel unit shows that the horizontal angle between the normal of the first area and the normal of the first pixel unit is ±10°, a pixel adjusting instruction containing adjustment angle information of −5° may be generated.

S212 is to adjust the angle of the first pixel unit in accordance with the pixel adjusting instruction such that the first area is in a preset range of the normal of the first pixel unit.

The angle of the first pixel unit may be adjusted by an expansion hinge and/or electrostatic stimulation spring in accordance with the pixel adjusting instruction such that the first area is in the preset range of the normal of the first pixel unit.

As shown in FIGS. 10 and 11, which are schematic diagrams of adjusting a pixel unit according to an embodiment of the disclosure, in FIGS. 10 and 11, a pixel unit 002 is connected to a substrate 001 via a connection mechanism 003 (an expansion hinge and/or electrostatic stimulation spring), and controls lengths of the left and right connection mechanisms 003 to adjust the angle of the pixel unit 002.

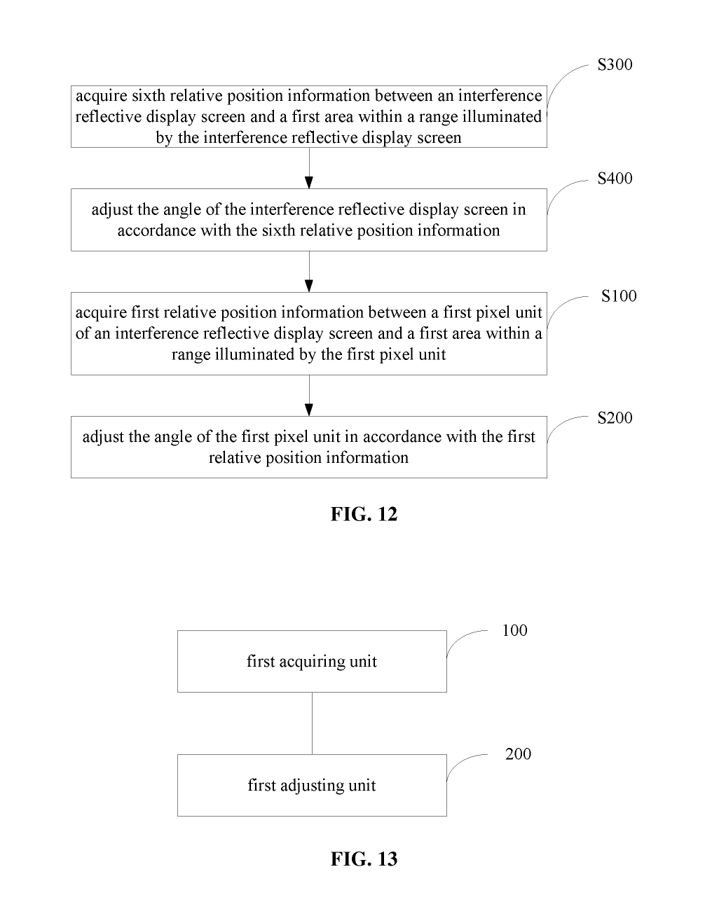

As shown in FIG. 12, in another display adjusting method according to an embodiment of the disclosure, the method may further include steps S300 and S400.

S300 is to acquire sixth relative position information between the interference reflective display screen and the first area in a range illuminated by the interference reflective display screen.

It should be understood that, it may obtain not only the relative position relationship between the pixel unit of the display screen and the first area but also the relative position relationship between the display screen and the first area.

S400 is to adjust the angle of the interference reflective display screen in accordance with the sixth relative position information.

Step S400 may be set to adjust the angle of the interference reflective display screen in accordance with the sixth relative position information such that the first area is in the preset range of the normal of the first pixel unit.

It should be understood by those skilled in the art that, since the adjustable range of the angle of the pixel unit is small, in the case where the relative position between the first area and the interference reflective display screen deviates large, the angle of the interference reflective display screen may be adjusted directly, thus it may be achieved that large range of angle is adjusted quickly.

It is to be noted that, through it is more appropriate that steps S300 and S400 are executed before steps S100 and S200, steps S300 and S400 may be executed simultaneously with steps S100 and S200. That is, the angle of the pixel unit of the display screen may also be adjusted during the adjustment of the angle of the display screen.

Corresponding to the embodiments of the method, a display adjusting system is also provided in the disclosure.

As shown in FIG. 13, a display adjusting system according to an embodiment of the disclosure includes a first acquiring unit 100 and an adjusting unit 200.

The first acquiring unit 100 is adapted to acquire first relative position information between a first pixel unit of an interference reflective display screen and a first area within a range illuminated by the first pixel unit.

The interference reflective display screen relates to the reflective technique based on interference modulation, which uses the ambient light as a light source and does not need backlight.

It should be understood that, there may be many pixel units in the interference reflective display screen, and each pixel unit may be adjusted by the method according to the disclosure.

It is to be noted that, a pixel unit of an interference reflective display screen generally has an illumination range due to the obstruction of various objects (for example, interior walls). For example, in the case where an interference reflective display screen is placed in a sitting room, the illumination range of a pixel unit of the interference reflective display screen may be the sitting room. In the case where a viewer views image information displayed on the interference reflective display screen, the viewer is generally within the illumination range of the pixel unit of the interference reflective display screen. For example, if an interference reflective display screen is placed in a sitting room, if a viewer wants to view the image information displayed on the interference reflective display screen, he should he in the sitting room, and not be outside the illumination range of a pixel unit of the interference reflective display screen (for example, another room separated by a wall).

The first area may be an area where a viewer is located.

The intensity of light interfered by a thin-film which is generated by a pixel unit of the interference reflective display screen may be obtained in accordance with the following Equation:

I=I1+I2+2A1*A2*cos θ=I1+I2+2A1*A2*cos(2Π*ΔL/λ). formula (1)

In formula (1), I denotes the intensity of interference light, I1 denotes the light intensity of interference beam 1, I2 denotes the intensity of interference beam 2, A1 denotes the amplitude of interference beam 1, A2 denotes the amplitude of interference beam 2, ΔL denotes an optical path difference between two interference beams, λ denotes the wave length of interference light, and θ denotes the phase difference between interference beam 1 and interference beam 2.

When ΔL=mλ/2 (where m is an integer), the light is enhanced due to the light coherent. It should be understood that, when interference beam 1 and interference beam 2 both emit along the normal direction of an air thin-film, ΔL is twice the thickness of the air thin-film (i.e., twice the distance between two reflecting layers). The thickness of the air thin-film is adjusted in such a way that ΔL meets ΔL=mλ₁/2. According to Equation (1), after interference, the intensity of light whose wave length is λ₁ is maximized. While if light is slanting into an eye under this thickness of the air thin-film, the optical path difference between two interference beams may deviate ΔL, and the wave length of the corresponding interfered light is λ₂, and λ₁ is not equal to λ₂, so chromatic aberration is generated. That is, the existing interference reflective display screen has the problem of chromatic aberration.

Since only the light ray the emitting direction of which deviates far away from the normal of a pixel unit can be seen in the case where a viewer is located far away from the normal of the pixel unit, the optical deflection is generated. The angle of the pixel unit may be adjusted based on the relative position relationship between the pixel unit and the position of the viewer, such that the viewer can view the light emitted from a position nearby the normal of the pixel unit without moving, and avoiding the optical deflection. Certainly, in the case where the viewer moves, according to the disclosure, the angle of the pixel unit may be adjusted in accordance with the position of the viewer so as to prevent from generating chromatic aberration.

The first area may also be an area where a light source is located.

Since the interference reflective display screen uses the ambient light as a light source, in the case where that the orientation of the display screen deviates from a light source which has a greater light intensity, the intensity of a light lay emitted from the display screen is lower. While in the case where a light source the light intensity of which is greater is located in the normal direction of the display screen, the intensity of a light lay emitted from the display screen is too high. Accordingly, the existing interference reflective display screen has the problem that its display brightness is not appropriate.

It should be understood that, since the interference reflective display screen is a display screen which uses the ambient light as a display light source, the intensity of the light illuminating the interference reflective display screen causes a great impact on the brightness of the screen of the interference reflective screen. In the case where the first area is an area where a light source is located, the pixel unit is adjusted in accordance with the relative position relationship between the pixel unit and the area where a light source is located, such that the interference reflective display screen can be illuminated by the light which has an appropriated light intensity and the optimization of the brightness of the interference reflective display screen is achieved.

The first area may also include an area where a viewer is located and an area where a light source is located.

It is to be noted that, in another embodiment of the disclosure, the area where a viewer is located and the area where a light source is located may be regarded as an integral area. Accordingly, it may achieve the effects of avoiding chromatic aberration and optimizing the brightness.

Thus, the first area may include an area where a viewer is located and/or an area where a light source is located.

The adjusting unit 200 is adapted to adjust the angle of the first pixel unit in accordance with the first relative position information.

The adjusting unit 200 may be adapted to adjust the angle of the first pixel unit in accordance with the first relative position information such that the normal of the first pixel unit passes through the first area.

In other embodiments of the disclosure, the angle of the first unit may also be adjusted by using other reference line or reference point as a reference. As an example, the vertical line of the center of an outside surface of a first pixel unit may be used.

The horizontal angle of the first pixel unit may be adjusted, the vertical angle of the first pixel unit may be adjusted, or both the horizontal angle and the vertical angle of the first pixel unit may be adjusted.

In practical application, the height of the first pixel unit may be adjusted. For example, if a viewer is tall, the height of the first pixel unit may be adjusted upper so that its height is suitable for the viewer. In addition, the horizontal position of the first pixel unit may be adjusted. For example, the horizontal position of the first pixel unit is adjusted front-back and left-right. It should be understood that, the adjusting manner also has a better practicability. In the case where the position where the viewer is located deviates from the normal direction of the interference reflective display screen, the horizontal direction of the interference reflective display screen may be adjusted such that the viewer is located in the normal direction of the display screen.

In practical application, each pixel unit may be adjusted separately, multiple pixel units may be adjusted uniformly, or the entire interference reflective display screen including all the pixel units may be adjusted, which is not limited here in the disclosure.

In a display adjusting system according to an embodiment of the disclosure, the relative position relationship between a pixel unit of the interference reflective display screen and a first area within a range illuminated by the first pixel unit may be acquired; and the angle of the pixel unit is adjusted in accordance with the relative position information. Since the angle of the interference reflective display screen may be adjusted in accordance with the surrounding environment in the disclosure, it enables the interference reflective display screen to adjust its angle in accordance with the surrounding environment automatically in the disclosure, thus the display effect of the interference reflective display screen is improved.

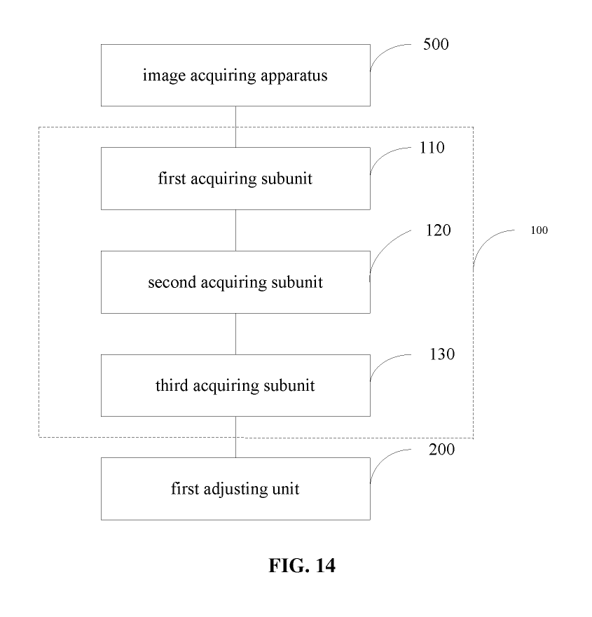

As shown in FIG. 14, in another display adjusting system according to an embodiment of the disclosure, the system may further include an image acquiring apparatus 500, and the first acquiring unit 100 may include a first acquiring subunit 110, a second acquiring subunit 120 and a third acquiring subunit 130.

The first acquiring subunit 110 is adapted to acquire second relative position information between the image acquiring apparatus and the first pixel unit.

The second acquiring subunit 120 is adapted to acquire third relative position information between the first area within a range illuminated by the first pixel unit and the image acquiring apparatus by using the image acquiring apparatus.

The image acquiring apparatus may be a camera.

It should be understood that, in order to not affect the display of the display screen and light emitted from the display screen, the image acquiring apparatus is generally provided on the outside of each pixel unit of the display screen, for example, at the upper edge of the display screen. Since only the relative position relationship between the image acquiring apparatus and the first area may be obtained from an image which is acquired from the image acquiring apparatus, it also needs to acquire relative position information between the image acquiring apparatus and the first pixel unit so as to obtain the relative position information between the first pixel unit and the first area.

The third acquiring subunit 130 is adapted to acquire the first relative position information between the first pixel unit of the interference reflective display screen and the first area in accordance with the second relative position information and the third relative position information.

It should be understood by those skilled in the art that, the first relative position information between the first pixel unit of the interference reflective display screen and the first area may be acquired by converting relative positions of the second relative position information and the third relative position information.

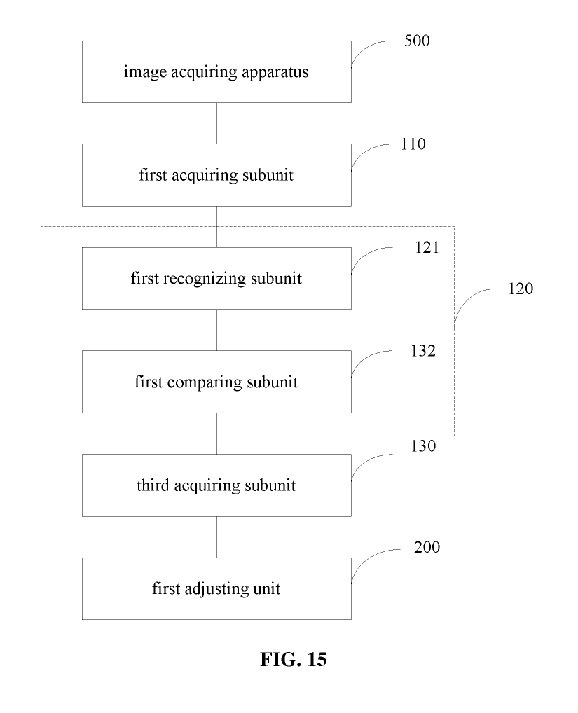

As shown in FIG. 15, in another display adjusting system according to an embodiment of the disclosure, in the case where the first area is an area where a viewer is located, the second acquiring subunit 120 may include a first recognizing subunit 121 and a first comparing subunit 122.

The first recognizing subunit 121 is adapted to recognize a facial image of the viewer from an image acquired by the image acquiring apparatus by using the face recognition technology.

The face recognition technology is used to recognize input facial image or video stream based on facial features. It may be judged firstly by the face recognition technology that whether there is a face. If there is a face, the position and size of each face and position information of each main facial organ may be further presented. Furthermore, identity characteristics which are implied in each face may be exacted in accordance with these information, and compared with the faces known, thus the identity of each face is recognized.

In the disclosure, it may only use the technology which judges whether there is a face in the face recognition technology, i.e., it only needs to recognize that there is a face. In another embodiment of the disclosure, it may use all the face recognition technology, and thus may recognize identity features corresponding to a facial image. The specific application may be as follows.

A white list of viewers is stored in advance, and the facial image information of the viewers is associated with the identify information and added into the white list of viewers.

The facial image acquired by the image acquiring apparatus may recognized by using the face recognition technology. If there is a facial image, it is further recognized that whether the facial image corresponds to at least one piece of facial image information of the white list of viewers. If the facial image corresponds to at least one piece of facial image information of the white list of viewers, the corresponding functions after the adjusting method of the interference reflective display screen according to the disclosure is applied in the electronic device are started. If the facial image does not correspond to at least one piece of facial image information of the white list of viewers, the function is not started.

The first comparing subunit 122 is adapted to compare the facial image with the image acquired by the image acquiring apparatus, and calculate third relative position information between the viewer and the image acquiring apparatus.

It should be understood that, on the premise of no zoom, if a face is more far away from the image acquiring apparatus, the facial image is smaller in an image acquired by the image acquiring apparatus. The distance between the face and the image acquiring apparatus may be determined in accordance with the size of the facial image. And the angle relationship between the face and the image acquiring apparatus may be determined in accordance with the distance and position relationship between the facial image and the center of the image acquire by the image acquiring apparatus. Finally, the third relative position relationship may be determined in accordance with the distance and angle obtained above.

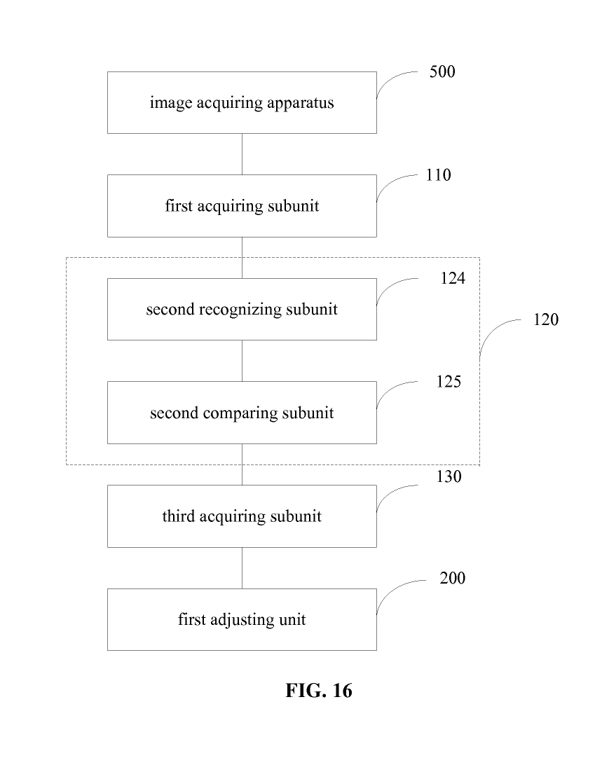

As shown in FIG. 16, in another display adjusting system according to an embodiment of the disclosure, in the case where the first area is an area where a light source is located, the second acquiring subunit 120 may include a second recognizing subunit 124 and a second comparing subunit 125.

The second recognizing subunit 124 is adapted to recognize an image of a light source area with the brightness greater than a first threshold from the image acquired by the image acquiring apparatus.

It should be understood that, except for self-luminous object, all objects may reflect light ray, therefore all objects may reflect light ray into the interference reflective display screen. Accordingly, objects which may reflect light ray into the interference reflective display screen may all be referred as light sources. The area where a light source is located may be referred as a light source area. It should be understood that, the brightness of an image corresponding to the area where a self-luminous object is located is larger.

In practical application, the brightness value may be obtained by judging the values of the three-color RGB of different positions in the image acquired by the image acquiring apparatus, and then compared with a first threshold to determine the light source area. For example, if the values of three-color RGB are all maximums, the corresponding part of the image is white and the brightness vale thereof is maximal may be determined as a light source with great brightness. Since determining brightness value from an image is known by those skilled in the art, for convenience, it is not described herein.

The second comparing subunit 125 is adapted to compare the image of the light source area with the image acquired by the image acquiring apparatus, and calculate third relative position information between the light source area and the image acquiring apparatus.

The comparison manner between the image of a light source and the image acquired by the image acquiring apparatus is the same as that between the facial image and the image acquired by the image acquiring apparatus in an embodiment as shown in FIG. 3. Please refer to the corresponding description for the specific manner.

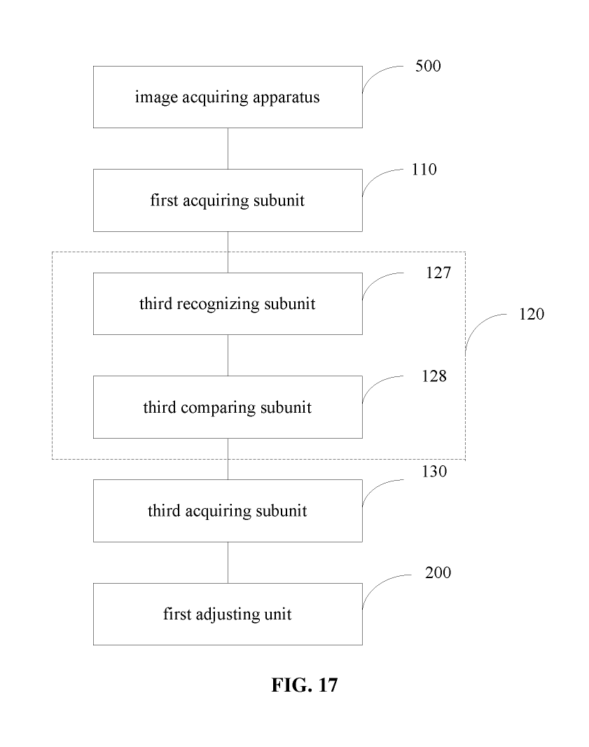

As shown in FIG. 17, in another display adjusting method according to an embodiment of the disclosure, in the case where the first area includes an area where a viewer is located and an area where a light source is located, the second acquiring subunit 120 may include a third recognizing subunit 127 and a third comparing subunit 128.

The third recognizing subunit 127 is adapted to recognize a facial image of the viewer from the image acquired by the image acquiring apparatus by using the face recognition technology, and recognize an image of the light source area the brightness greater than a first threshold from an image acquired by the image acquiring apparatus.

In practical application, in the case where a facial image and an image of a light source area are acquired by image acquiring apparatus, the facial image and the image of a light source may be recognized.

The third comparing subunit 128 is adapted to compare the facial image with the image acquired by the image acquiring apparatus, and calculate fourth relative position sub-information; compare the image of the light source area with the image acquired by the image acquiring apparatus, and calculate fifth relative position sub-information; and set the fourth relative position sub-information and the fifth relative position sub-information as the third relative position information which indicates that the relative position between the first area in the illumination rang of the first pixel unit and the image acquiring apparatus.

After the facial image and the image of a light source are recognized, the fourth relative position relationship between the facial image and the image acquiring apparatus and the fifth relative position relationship between the light source and the image acquiring apparatus may be obtained respectively, and the fourth relative position relationship and the fifth relative position relationship are set together as the third relative position relationship used to adjust the angle of the display screen, so as to solve the problem of chromatic aberration and inappropriate brightness.

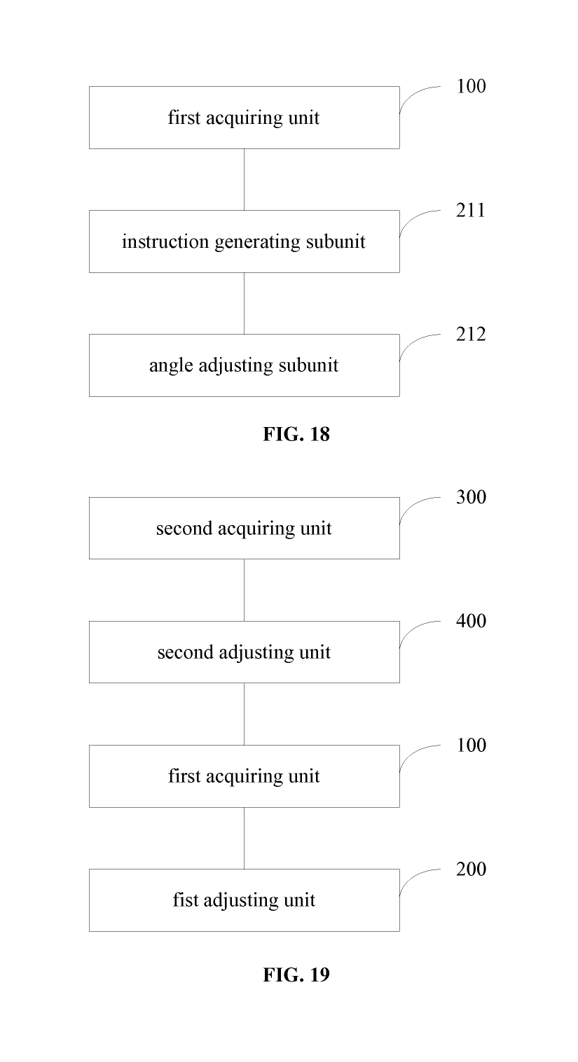

As shown in FIG. 18, in another display adjusting system according to an embodiment of the disclosure, the second adjusting unit 200 may include an instruction generating subunit 211 and an angle adjusting subunit 212.

The instruction generating subunit 211 is adapted to generate a pixel adjusting instruction containing adjustment angle information in accordance with the first relative position information.

In the case where the preset range is ±5° and the first relative position information between the first area and the first pixel unit shows that the horizontal angle between the normal of the first area and the normal of the first pixel unit is ±10°, a pixel adjusting instruction containing adjustment angle information of −5° may be generated.

The angle adjusting subunit 212 is adapted to adjust the angle of the first pixel unit in accordance with the pixel adjusting instruction such that the first area is in a preset range of the normal of the first pixel unit.

The angle of the first pixel unit may be adjusted by an expansion hinge and/or electrostatic stimulation spring in accordance with the pixel adjusting instruction such that the first area is within the preset range of the normal of the first pixel unit.

The angle adjusting subunit 212 may be set to adjust the angle of the first pixel unit by an expansion hinge and/or electrostatic stimulation spring in accordance with the pixel adjusting instruction such that the first area is within the preset range of the normal of the first pixel unit.

As shown in FIG. 19, in another display adjusting system according to an embodiment of the disclosure, the system may further include a second acquiring unit 300 and a second adjusting unit 400.

The second acquiring unit 300 is adapted to acquire sixth relative position information between the interference reflective display screen and the first area in a range illuminated by the interference reflective display screen.

It should be understood that, it may obtain not only the relative position relationship between the pixel unit of the display screen and the first area but also the relative position relationship between the display screen and the first area.

The second adjusting unit 400 is adapted to adjust the angle of the interference reflective display screen in accordance with the sixth relative position information.

The second adjusting unit 400 may be set to adjust the angle of the interference reflective display screen in accordance with the sixth relative position information such that the first area is within the preset range of the normal of the first pixel unit.

It should be understood by those skilled in the art that, since the adjustable range of the angle of the pixel unit is small, in the case where the relative position between the first area and the interference reflective display screen deviates large, the angle of the interference reflective display screen may be adjusted directly, thus it may be achieved that large range of angle is adjusted quickly.

It should be noted that, a relational term such as “the first” and “the second” herein is only used to distinguish one entity or operation from another entity or operation, and does not necessarily require or imply that there is an actual relationship or sequence between these entities or operations. Furthermore, terms “including”, “comprising” or any other variations thereof are intended to cover non-exclusive “including”, so that a process, a method, an object or a device including a series of elements not only includes these elements, but also includes other elements not explicitly listed, or further includes elements inherent in the process, the method, the object or the device. In the absence of more restrictions, element defined by a sentence “includes a . . . ” does not exclude that there is other same elements in the process, the method, the object or the device including said element.

Those described above are only embodiments of the present invention. It should be noted that, for the skilled in the art, improvements and modifications may also be made without departing from the principle of the invention. Those improvements and modifications should also be included in the scope of protection of the present invention.

1. A display adjusting method applied to an electronic device comprising a display unit which has a touch function and comprises a touch sensing unit adapted to receive a touch operation of a user, wherein the method comprises:
judging whether chromatic aberration is generated in the touch sensing unit to obtain a first judgment result;
judging whether the chromatic aberration meets a preset condition to obtain a second judgment result in the case where the first judgment result indicates that the chromatic aberration is generated in the touch sensing unit; and
adjusting display parameters of the display unit based on the chromatic aberration to correct the chromatic aberration in the case where the second judgment result indicates that the chromatic aberration meets the preset condition.

2. The method according to claim 1, wherein the touch sensing unit is a thin-film sensing touch screen.

3. The method according to claim 1, wherein the chromatic aberration is yellowish chromatic aberration;
the preset condition is that a chromatic aberration value exceeds a preset chromatic aberration threshold; and
the display parameters comprise a color parameter, a brightness, a contrast and a saturation.

4. The method according to claim 1, wherein the adjusting display parameters of the display unit based on the chromatic aberration correct the chromatic aberration comprises:
adjusting the display parameters of the display unit in accordance with a time-based changing curve of a chromatic aberration value of the touch sensing unit to correct the chromatic aberration; or
acquiring a current chromatic aberration value of the touch sensing unit, and adjusting the display parameters of the display unit in accordance with the chromatic aberration value to correct the chromatic aberration.

5. A display adjusting method, comprising:
acquiring first relative position information between a first pixel unit of an interference reflective display screen and a first area in a range illuminated by the first pixel unit; and
adjusting an angle of the first pixel unit in accordance with the first relative position information.

6. The method according to claim 5, wherein the adjusting the angle of the first pixel unit in accordance with the first relative position information comprises:
adjusting the angle of the first pixel unit in accordance with the first relative position information such that the first area is within a preset range of a normal of the first pixel unit.

7. The method according to claim 5, wherein the first area comprises at least one of an area where a viewer is located and an area where a light source is located.

8. The method according to claim 5, wherein an image acquiring apparatus is further provided on the interference reflective display screen, and the acquiring the first relative position information between a first pixel unit of an interference reflective display screen and a first area in a range illuminated by the first pixel unit comprises:
acquiring second relative position information between the image acquiring apparatus and the first pixel unit, and acquiring third relative position information between the first area in a range illuminated by the first pixel unit and the image acquiring apparatus by using the image acquiring apparatus; and
acquiring the first relative position information between the first pixel unit of the interference reflective display screen and the first area in accordance with the second relative position information and the third relative position information.

9. The method according to claim 8, wherein in the case where the first area is the area where the viewer is located, the acquiring the third relative position information between the first area within a range illuminated by the first pixel unit and the image acquiring apparatus by using the image acquiring apparatus comprises:
recognizing a facial image of the viewer from an image acquired by the image acquiring apparatus by using face recognition technology; and
comparing the facial image with the image acquired by the image acquiring apparatus, and calculating the third relative position information between the viewer and the image acquiring apparatus.

10. The method according to claim 8, wherein in the case where the first area is the area where the light source is located, the acquiring the third relative position information between the first area in a range illuminated by the first pixel unit and the image acquiring apparatus by using the image acquiring apparatus comprises:
recognizing an image of a light source area with brightness greater than a first threshold from an image acquired by the image acquiring apparatus; and
comparing the image of the light source area with the image acquired by the image acquiring apparatus, and calculating the third relative position information between the light source area and the image acquiring apparatus.

11. The method according to claim 8, wherein in the case where the first area comprises the area where the viewer is located and the area where the light source is located, the acquiring the third relative position information between the first area in a range illuminated by the first pixel unit and the image acquiring apparatus by using the image acquiring apparatus comprises:
recognizing a facial image of the viewer from an image acquired by the image acquiring apparatus by using face recognition technology, and recognizing an image of the light source area with brightness greater than a first threshold from the image acquired by the image acquiring apparatus; and
comparing the facial image with the image acquired by the image acquiring apparatus, and calculating fourth relative position sub-information between the viewer and the image acquiring apparatus; comparing the image of the light source area with the image acquired by the image acquiring apparatus, and calculating fifth relative position sub-information between the light source area and the image acquiring apparatus; and setting the fourth relative position sub-information and the fifth relative position sub-information as the third relative position information between the first area in the range illuminated by the first pixel unit and the image acquiring apparatus.

12. The method according to claim 6, wherein the adjusting the angle of the first pixel unit in accordance with the first relative position information such that the first area is within the preset range of the normal of the first pixel unit comprises:
generating a pixel adjusting instruction containing adjustment angle information in accordance with the first relative position information; and
adjusting the angle of the first pixel unit in accordance with the pixel adjusting instruction such that the first area is within the preset range of the normal of the first pixel unit.

13. (canceled)

13. The method according to claim 5, further comprising:
acquiring sixth relative position information between the interference reflective display screen and the first area in the range illuminated by the interference reflective display screen; and
adjusting the angle of the interference reflective display screen in accordance with the sixth relative position information.

14. The method according to claim 13, wherein the adjusting the angle of the interference reflective display screen in accordance with the sixth relative position information comprises: adjusting the angle of the interference reflective display screen in accordance with the sixth relative position information to make t the first area is in the preset range of the normal of the first pixel unit.

15. An electronic device comprising a display unit which has touch ability and comprises a touch sensing unit adapted to receive a touch operation of a user, wherein the electronic device further comprises a display adjusting apparatus which comprises:
a first judgment module, adapted to judge whether chromatic aberration is generated in the touch sensing unit to obtain a first judgment result;
a second judgment module adapted to judge whether the chromatic aberration meets a preset condition to obtain a second judgment result in the case where the first judgment result indicates that the chromatic aberration is generated in the touch sensing unit; and
an adjusting module, adapted to adjust display parameters of the display unit based on the chromatic aberration to correct the chromatic aberration in the case where the second judgment result indicates that the chromatic aberration meets the preset condition.

16. The electronic device according to claim 15, wherein the touch sensing unit is a thin-film sensing touch screen.

17. The electronic device according to claim 15, wherein the chromatic aberration is yellowish chromatic aberration;
the preset condition is that the chromatic aberration value of the chromatic aberration exceeds a preset chromatic aberration threshold; and
the display parameters comprise a color parameter, a brightness, a contrast and a saturation.

18. The electronic device according to claim 15, wherein the adjusting module is adapted to:
adjust the display parameters of the display unit in accordance with a time-based changing curve of a chromatic aberration value of the touch sensing unit to correct the chromatic aberration; or
acquire a current chromatic aberration value of the touch sensing unit, and adjust the display parameters of the display unit in accordance with the chromatic aberration value to correct the chromatic aberration.

19. A display adjusting system comprising a first acquiring unit and a first adjusting unit, wherein:
the first acquiring unit is adapted to acquire first relative position information between a first pixel unit of an interference reflective display screen and a first area in a range illuminated by the first pixel unit; and
the first adjusting unit is adapted to adjust the angle of the first pixel unit in accordance with the first relative position information.

20. The system according to claim 19, wherein the first adjusting unit is adapted to:
adjust the angle of the first pixel unit in accordance with the first relative position information such the first area is in a preset range of the normal of the first pixel unit.

21. The system according to claim 19, wherein the first area comprises at least one of an area where a viewer is located and an area where a light source is located.

22. The system according to claim 19, further comprising an image acquiring apparatus which comprises a first acquiring subunit, a second acquiring subunit, and a third acquiring subunit, wherein:
the first acquiring subunit is adapted to acquire second relative position information between the image acquiring apparatus and the first pixel unit;
the second acquiring subunit is adapted to acquire third relative position information between a first area in the range illuminated by the first pixel unit and the image acquiring apparatus by using the image acquiring apparatus; and
the third acquiring subunit is adapted to acquire the first relative position information between the first pixel unit of the interference reflective display screen and the first area in accordance with the second relative position information and the third relative position information.

23. The system according to claim 22, wherein in the case where the first area is the area where the viewer is located, the second acquiring subunit comprises a first recognizing subunit and a first comparing subunit, and wherein:
the first recognizing subunit is adapted to recognize a facial image of the viewer from an image acquired by the image acquiring apparatus by using face recognition technology; and
the first comparing subunit is adapted to compare the facial image with the image acquired by the image acquiring apparatus, and calculate third relative position information between the viewer and the image acquiring apparatus.

24. The system according to claim 22, wherein in the case where the first area is the area where the light source is located, the second acquiring subunit comprises a second recognizing subunit and a second comparing subunit, and wherein:
the second recognizing subunit is adapted to recognize an image of the light source area with brightness greater than a first threshold from the image acquired by the image acquiring apparatus; and
the second comparing subunit is adapted to compare the image of the light source area with the image acquired by the image acquiring apparatus, and calculate third relative position information between the light source area and the image acquiring apparatus.

25. The system according to claim 22, wherein in the case where the first area comprises the area where a viewer is located and an area where a light source is located, the second acquiring subunit comprises a third recognizing subunit and a third comparing subunit, and wherein:
the third recognizing subunit is adapted to recognize a facial image of the viewer from an image acquired by the image acquiring apparatus by using the face recognizing technique, and recognize an image of the light source area with the brightness greater than a first threshold from an image acquired by the image acquiring apparatus; and
the third comparing subunit is adapted to compare the facial image with the image acquired by the image acquiring apparatus, and calculate fourth relative position sub-information between the viewer and the image acquiring apparatus; compare the image of the light source area with the image acquired by the image acquiring apparatus, and calculate fifth relative position sub-information between the light source area and the image acquiring apparatus; and set the fourth relative position sub-information and the fifth relative position sub-information as the third relative position information.

26. The system according to claim 20, wherein the first adjusting unit comprises an instruction generating subunit and an angle adjusting subunit, and wherein:
the instruction generating subunit is adapted to generate a pixel adjusting instruction containing adjustment angle information in accordance with the first relative position information; and
the angle adjusting subunit is adapted to adjust the angle of the first pixel unit in accordance with the pixel adjusting instruction to make the first area is in the preset range of the normal of the first pixel unit.

27. The system according to claim 26, wherein the angle adjusting subunit is adapted to:
adjust the angle of the first pixel unit by an expansion hinge and/or electrostatic stimulation spring in accordance with the pixel adjusting instruction such that the first area is within the preset range of the normal of the first pixel unit.

28. The system according to claim 19, further comprising a second acquiring unit and a second adjusting unit, wherein:
the second acquiring unit is adapted to acquire sixth relative position information between the interference reflective display screen and the first area within a range illuminated by the interference reflective display screen; and
the second adjusting unit is adapted to adjust the angle of the interference reflective display screen in accordance with the sixth relative position information.

29. The system according to claim 28, wherein the second adjusting unit is adapted to:
adjust the angle of the interference reflective display screen in accordance with the sixth relative position information such that the first area is within the preset range of the normal of the first pixel unit.

30. The method according to claim 12, wherein the adjusting the angle of the first pixel unit in accordance with the pixel adjusting instruction such that the first area is within the preset range of the normal of the first pixel unit comprises:
adjusting the angle of the first pixel unit by an expansion hinge and/or electrostatic stimulation spring in accordance with the pixel adjusting instruction such that the first area is within the preset range of the normal of the first pixel
